(19) United States
(12) Patent Application Publication
(10) Pub. No.: US 2008/0149389 A1
(43) Pub. Date: Jun. 26, 2008

(54) Method of Using the Earth Mantle Substance for Hydrogen Production

(76) Inventor: Vladimir Nikolaevich Larin, Moscow (RU)

Correspondence Address: ABELMAN, FRAYNE & SCHWAB, 666 THIRD AVENUE, 10TH FLOOR, NEW YORK, NY, 10017, US

(21) Appl. No.: 10/567,695

(22) PCT Filed: Dec. 24, 2003
(86) PCT No.: PCT/RU2003/000577

§ 371 Date: Feb. 3, 2006

(30) Foreign Application Priority Data
Oct. 15, 2003 (RU) 2003130407

(51) Int. Cl. E21B 7/00

(52) U.S. Cl. 175/4.5; 166/271

(57) ABSTRACT

A method of using the Earth mantle substance for hydrogen production. Area of application is production of cheap and efficient energy resources, in particular, a fuel for internal-combustion engine. The substance of invention is an exploration of continental and oceanic rifting areas, supported by abnormal mantle diapers with the mantle substance fingers outlet into the Earth's crust. The mantle substance wells drilling with help of turbodrills. A reaction cavity can be formed by injection and production wells linkage and/or production wells reaming after the well inlet into the mantle substance. The water is supplied into the injection well, and hydrogen gas, produced in reaction of water with intermetallic compounds, contained in the mantle substance, is brought to the surface by the production well.

### CROSS-REFERENCE TO RELATED APPLICATIONS

This application is a 371 of international application number PCT/RU2003/000577, filed on Dec. 24, 2003, which is incorporated herein by reference in its entirety.

### BACKGROUND OF THE INVENTION

1. Field of the Invention

The invention is devoted to production of cheap and effective energy resources, in particular hydrogen, which is used as an energy carrier for power industry and transport.

2. Description of the Related Art

One of the well-known methods of hydrogen production assumes application of deep high-thermal waters in the places of underwater volcanic activity for power production, supplied for water electrolysis, which results in hydrogen produced (see SU 1624162, published 30.01.1991). Another method assumes a supply of powdered aluminum or aluminum hydride and aqueous medium to a reactor and their further interaction. Before the reactor stage, powdered aluminum or aluminum hydride should be coated by a water-miscible polymer film based on a solution of polyethylene oxide in diethylene dioxide or methyl hydroxide; meanwhile, in order to provide a layer-by-layer combustion of metallic materials with hydrogen release, the procedure should be performed at the pressure at least 22.12 MPa and a temperature over 647.3 K (see RU 2165388).

Another method assumes an ecologically safe chemical fuel production with reactions of low temperature nuclear fusion in a nuclear reactor. Nuclear reactor waste products and deuterium are used as initial agents to produce neutrons. As nuclear fusion is performed, the agent captures the slow neutrons radiated, and the released nuclear energy is transformed into electricity, which is applied for water electrolysis to obtain hydrogen and oxygen (see RU 2180366, published on Mar. 10, 2002).

Another method assumes using the Earth mantle substance to produce hydrogen. This includes an exploration of continental and oceanic rifting areas, supported by abnormal mantle diapirs with mantle substance fingers outward to the Earth's crust, the mantle substance well drilling, well water supply inflow, and then hydrogen gas extraction out of the well. The hydrogen gas is obtained via reaction of water with intermetallic compounds (silicides) and alloys of Si, Mg, Fe (silicon, magnesium and iron) that exist in the mantle substance (see Chemistry and Life No. 10, 2000, pp. 46-51).

The well-known methods are characterized by complicated equipment requirements, significant energy cost due to high power consumption for aluminum production and additional energy consumption for polymer production, high pressure and temperature maintenance, high danger of radioactive environmental pollution around the production location, relatively low efficiency and, as a result, high energy consumption values comparable to energy consumption required to obtain hydrogen by most conventional methods, for example, water electrolysis.

### BRIEF SUMMARY OF THE INVENTION

This invention is devoted to a task of increasing an economic efficiency of hydrogen power industry and reduction in specific energy consumption connected with hydrogen production.

The specified technical result is achieved in the following way: according to the invention, a reaction cavity area should be formed at the well inlet to the mantle substance, hydrogen release is controlled by change in water volume in the reaction cavity, meanwhile the reaction cavity surface, involved in the reaction, should be regenerated periodically, which should be implemented based on the well-known method of hydrogen production using the Earth mantle substance, which includes exploration of continental and oceanic rifting areas, supported by abnormal mantle diapirs with the mantle substance fingers outward to the Earth's crust, the mantle substance well drilling, well water supply inflow, and then hydrogen gas extraction out of the well, which is generated via water reaction with intermetallic compounds of the mantle substance.

This combination of features provides a technical result in all situations, on which the required extent of appropriate protection is spread on. In particularly, the reaction cavity formation allows the obtaining of a wide surface of water contact with the mantle substance and, consequently, to increase hydrogen generation. Periodical regeneration of the reacting surface allows the maintaining of this surface in reactive condition and even to enlarge it. Therefore, hydrogen output is increased while constant energy consumption occurs for well drilling, water supply etc., which results in a decrease of specific energy consumption for hydrogen production.

In particular cases (in specific configurations or special conditions), the invention is characterized by the following features:

well drilling is performed with the help of turbodrills;

an additional well is drilled, and a reaction cavity is formed by linkage of the main and additional wells;

the reaction cavity is formed by reaming the main and/or additional wells;

well reaming is performed by a blast of explosive materials;

the reaction surface regeneration is performed by high-pressure water flow;

high-pressure water flow is supplied through nozzles, installed in the reaction cavity, at a remotely controlled manipulator system;

a separator is installed in the well or at the well outlet to divide generated hydrogen gas and water vapors; and

heat energy, discharged during hydrogen production, can be utilized.

### DETAILED DESCRIPTION OF THE INVENTION

According to this invention, hydrogen production using the Earth mantle substance is arranged in the following way.

An exploration of continental and ocean rifting areas is performed by modern methods of exploration and soil investigation, for example, airspace-based. The rifting areas, supported by abnormal mantle diapirs, are selected among the found areas. The rifting areas can be considered as the most prospective for hydrogen production, if supported by abnormal mantle diapirs with mantle substance fingers that come out into the Earth's crust at the depth of 3-5 km (up to 10 km). According to development of the deep drilling and ultradeep drilling methods, this depth can be increased.

Since the prospective areas are determined, the sites for drilling equipment installation should be prepared. If an ocean rifting area is considered as a prospective one, the offshore drilling platform is installed. After preliminary work is finished, at least one well should be drilled into the mantle substance, which is based on rotary drilling technology, for example, by turbodrills, or hydraulic rotary drilling technology.

A drill stem trip is performed with extended “stalks” during maximal extent of process mechanization and automation. Drillings removal is performed by drilling mud circulation. Water-based solutions are used as drilling mud fluids at the start of a well installation. When temperature in the well raises from 240° C. up to 300° C., it should be changed by application of oil-emulsion solutions, and if over 300° C., oil-based solutions are applied. Depending on specified geologic and technical conditions, drilling heads of rolling or abrasive types are used.

As far as drilling advances, the stability of rocks at well bores, in conditions of rock and reservoir pressure, should be achieved by maintenance of a required backpressure in the drilling mud column and its quality, and if low pressure reservoirs are encountered, the well bore should be cased by casing string and cemented.

The most preferred option should be the one in which several wells, main and additional, are drilled, one of which can be used to supply water, i.e. as an injection, and others are used as production wells, by which reaction hydrogen produced is discharged to the surface. After wells are inserted into the mantle substance, the bores are freed from drilling mud fluid, and a reaction cavity is formed, where a reaction of water with intermetallic compounds, included in the mantle substance, and hydrogen release are performed. Application of salt water (for example, sea water) increases reaction kinetics.

A reaction cavity can be formed by injection and production wells linkage and by injection and/or production wells reaming. In its turn, well reaming is possibly performed by explosion of explosive material, lowered down to the well bottom.

The wellhead equipment is installed to provide injection and production wells heads sealing, and flow distribution and control of injected water and correspondingly produced hydrogen. Tubing string heads, casing heads, and check and control valves are installed as wellhead equipment.

Then water is supplied into the equipped injection well, and hydrogen gas, which is a result of the reaction of intermetallic compound with water, is brought to the surface through an equipped output production well. To direct the produced hydrogen into the production well, the water supply well bore should be sealed at the wellhead and right before the reaction cavity interfacing linkage, providing the only water passage. In this case, hydrogen, produced in reaction, will be released through the production well opened at the surface.

The production well can also be equipped by vacuum units, which reduce pressure in the production well bore. In this case, hydrogen, produced in reaction, will be released through the production well under the influence of pressure reduction.

The quantity of produced hydrogen (hydrogen output) is controlled by a change of supplied water volume and, according to this, by a change of reaction cavity water volume. This control can be performed, for example, by a decrease of a check valves flow profile at the production wellhead and a decrease of returned water flow at its constant supply rate to the production well. As a result, the quantity of water, reacting with intermetallic compounds in the reaction cavity, increases, and hydrogen output increases consequently.

The requirement of an increase or decrease of the quantity of reaction cavity water is considered according to the quantity of hydrogen release.

A surface, which is involved in reaction, is regenerated periodically as far as intermetallic compounds oxidize. The specified surface regeneration is performed, for example, by high pressure water flow. High-pressure water flow is supplied through nozzles, installed in the reaction cavity, at a remotely controlled manipulator system. Oxidation products are removed from the reaction cavity by supplied water flow and brought to the surface, where they can be utilized.

A separator can be installed in the production well to divide generated hydrogen gas and water vapors.

### SUBSTANTIATION OF INVENTION APPLICABILITY FOR INDUSTRIAL PURPOSES

According to the above mentioned example of one of the best implementation versions, which are presented by the applicant, it stands to reason how the described method of hydrogen production using the Earth mantle substance can be applied to produce cheap and efficient energy resources, hydrogen in particular, which can be applied as an energy carrier for power industry and transport, or for industry and civil buildings heating.

1-9. (canceled)

10. A method of using the Earth mantle substance to produce hydrogen, the method comprising the steps of:
inserting a plurality of wells into the mantle substance;
forming a reaction cavity in the mantle substance, wherein the reaction cavity includes a reaction cavity surface;
applying water through a first well to the reaction cavity to interact with intermetallic compounds contained in the mantle substance, thereby causing a reaction of the water with the intermetallic compounds to release hydrogen;
controlling the release of the hydrogen by changing the water volume in the reaction cavity;
regenerating the reaction cavity surface involved in the reaction; and
extracting the hydrogen out of a second well.

11. The method according to claim 10, wherein the step of inserting the plurality of wells includes drilling.

12. The method according to claim 11, wherein the step of inserting the plurality of wells includes drilling using turbodrills.

13. The method according to claim 10, wherein the step of forming the reaction cavity includes the step of:
establishing a linkage between the first and second wells, wherein the linkage includes the reaction cavity.

14. The method according to claim 12, wherein the step of forming the reaction cavity includes the step of:
drilling a linkage between the first and second wells using the turbodrills, wherein the linkage includes the reaction cavity.

15. The method according to claim 10, wherein the step of forming the reaction cavity includes the step of:
reaming at least one of the first and second wells.

16. The method according to claim 12, wherein the step of forming the reaction cavity includes the step of:
reaming at least one of the first and second wells using the turbodrills.

17. The method according to claim 15, wherein the step of reaming is performed by explosion of explosive materials.

18. The method according to claim 10, wherein the step of regenerating the reaction cavity surface is performed periodically.

19. The method according to claim 10, wherein the step of regenerating the reaction cavity surface is performed by high-pressure water flow.

20. The method according to claim 19, further comprising the steps of:
installing a nozzle in the reaction cavity for providing the high-pressure water flow.

21. The method according to claim 20, wherein the step of installing includes:
installing the nozzle using a remotely controlled manipulator system.

22. The method according to claim 10, further comprising:
installing a separator to divide the released hydrogen from any water vapors.

23. The method according to claim 22, wherein the released hydrogen is in gaseous form prior to division from the water vapors by the separator.

24. The method according to claim 22, wherein the separator is installed on the second well.

25. The method according to claim 22, wherein the separator is installed on an outlet associated with at least one of the plurality of wells.

26. The method according to claim 10, further comprising:
utilizing heat energy discharged during the release of the hydrogen.

27. An improved method of using the Earth mantle substance to produce hydrogen, including exploring continental and oceanic rifting areas supported by abnormal mantle diapirs with the mantle substance near the crust of the Earth; inserting a plurality of wells into the mantle substance; applying water through a water well of the plurality of wells to interact with intermetallic compounds contained in the mantle substance, thereby causing a reaction of the water with the intermetallic compounds to release hydrogen; and extracting the hydrogen out of a production well of the plurality of wells, the improvement comprising the steps of:
L after inserting the plurality of wells into the mantle substance, forming a reaction cavity in the mantle substance, wherein the reaction cavity includes a reaction cavity surface;
controlling the release of the hydrogen by changing the water volume in the reaction cavity; and
regenerating periodically the reaction cavity surface involved in the reaction.

28. The improved method of claim 28, wherein the step of forming the reaction cavity includes the step of:
establishing a linkage between the water well and the production well, wherein the linkage includes the reaction cavity.

29. The improved method of claim 28, wherein the step of forming the reaction cavity includes the step of:
reaming at least one of the water well and the production well.
